(19) United States
(12) Patent Application Publication
(10) Pub. No.: US 2009/0071454 A1
(43) Pub. Date: Mar. 19, 2009

(54) IGNITION COIL HAVING COMPRESSED POWDER CORE

(75) Inventor: Norihito Fujiyama, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/207,527

(22) Filed: Sep. 10, 2008

(30) Foreign Application Priority Data
Sep. 14, 2007 (JP) 2007-239960
Jun. 30, 2008 (JP) 2008-169962

(51) Int. Cl. F02P 3/04

(52) U.S. Cl. 123/621; 123/634

(57) ABSTRACT

An ignition coil includes a generally cylindrical center core having a plurality of cylindrical portions whose outside diameter is different from each other, a primary coil disposed around the center core; and a secondary coil disposed around the primary coil, wherein the secondary coil boosts voltage that is applied to the primary coil to high voltage.

### CROSS REFERENCE TO RELATED APPLICATION

The present application is based on and claims priority from Japanese Patent Applications 2007-239960 filed Sep. 14, 2007, and 2008-169962 filed Jun. 30, 2008, the contents of which are incorporated herein by reference.

### BACKGROUND OF THE INVENTION

1. Field of the Invention

The present invention relates to an ignition coil for applying high voltage to a spark plug of an internal combustion engine

2. Description of the Related Art

An ignition coil that includes a primary coil and a secondary coil is well-known for boosting voltage of the primary coil by means of the mutual inductance of the primary coil and the secondary coil.

For example, JP-A-2007-81085 discloses an ignition coil which includes a laminar of magnetic steel sheets used as a center core, a primary coil wound around the center core via a first resinous spool member and a secondary coil wound around the primary coil via a second resinous spool member. Because the lamination of magnetic steel sheets has many sharp edges projecting outward, the first resinous spool member has to protect the primary coil from the edges.

Accordingly, the first resinous spool member has a considerable thickness to have a protecting mechanical strength, which inevitably increases the outside diameter of the primary and the secondary coils.

### SUMMARY OF THE INVENTION

Therefore, an object of the invention is to provide a compact ignition coil that has a comparatively small outside diameter.

Another object of the invention is to provide an improved center core that can accommodate a primary coil within a reduced accommodation space of the primary coil.

According to a feature of the invention, an ignition coil includes a generally cylindrical center core having a plurality of cylindrical portions whose outside diameter is different from each other, a primary coil disposed around the center core and a secondary coil disposed around the primary coil to boost voltage applied to the primary coil to high voltage.

Because the center core that has stepped cylindrical portions whose outside diameter is smaller than the main portion thereof, the center core can accommodate more layers of insulated electric wires to form a primary coil than a conventional one. Therefore, necessary magnetic performance of the ignition coil can be ensured.

In the above ignition coil: the primary coil may include an even number of winding layers, so that the both ends of the primary coil can be drawn from the same end of the center core; and the center core may have a longitudinally extending groove by which an end of the primary coil is drawn from one end of the center core to the other end.

The above ignition coil may further include an outer core that surrounds the center core to form a magnetic path that includes the center core and an air gap formed between the outer core and one end of the center core. In this case, one of the cylindrical portions that has a smallest outside diameter is disposed adjacent to the air gap. When primary current is supplied to the primary coil that is wound around the center core, the magnetic flux density in a portion of the center core becomes smaller as the portion nears the air gap. Therefore, magnetic saturation in the second cylindrical portion can be moderated.

In the above ignition coil, there are the following additional features: the center core may be made of compressed powder of magnetic material or a laminate of plural magnetic steel sheets if the outer surface of the center core is covered with a thin film of insulating material; the outside diameter of the cylindrical portions of the center core may reduce stepwise in a longitudinal direction; the center core may have a tapering wall between two of the cylindrical portions; one of the cylindrical portions adjacent to another cylindrical portion may have a tapering surface tapering off from the side of the another cylindrical portion to opposite side, wherein the center core may have a flange portion adjacent to the opposite side of the one of the cylindrical portion that has the tapering surface.

In the above ignition coil, a step difference S and a difference ΔN in the number of turns of the primary coil between the cylindrical portions adjacent to each other may be expressed as follows: S≧Φ×ΔN×C, wherein: Φ is an outside diameter of an electric wire of the primary coil; and C is a diameter reduction ratio of the electric wire that is wound around the cylindrical portions under a prescribed winding tension.

According to another feature of the invention, an ignition coil includes a center core made of compressed powder of magnetic material, a primary coil disposed around the center core and a secondary coil disposed around the primary coil to boost voltage applied to the primary coil to high voltage.

Therefore, sharp edges of the center core can be eliminated and an insulating spool member that insulates the primary coil from the center core can be omitted. As a result, a compact ignition coil can be provided.

In this ignition coil, the center core may have a first cylindrical portion and a second cylindrical portion having a diameter that is smaller than the first cylindrical portion.

The primary coil may include an even number of winding layers disposed at the first cylindrical portion and another even number of winding layers disposed at the second cylindrical portion. In this case, both ends of the primary coil can be drawn from the same end of the center core, so that connection with a control circuit can be mace easier. The center core may have a flange portion at an end thereof.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a cross-sectional side view of an ignition coil according to the first embodiment of the invention;

FIG. 2 is an enlarged cross-sectional longitudinal view of a portion of the ignition coil shown in FIG. 1;

FIG. 3 is an enlarged cross-sectional view of the ignition coil shown in FIG. 1 cut along line III-III;

FIG. 4 is a schematic diagram illustrating a step of winding an insulated electric wire around a center core of the ignition coil shown in FIG. 2;

FIGS. 5A, 5B and 5C illustrate steps of forming a cylindrical center core to be used in the ignition coil shown in FIG. 1;

FIG. 6 is a schematic diagram illustrating a step of winding a primary coil around a first cylindrical portion of the center core;

FIG. 7 is a schematic diagram illustrating a winding step after the step shown in FIG. 4;

FIG. 8 is an enlarged cross-sectional view of the ignition coil shown in FIG. 1 cut along line VIII-VIII;

FIG. 9 is a cross-sectional longitudinal view of an ignition coil according to the second embodiment of the invention;

FIG. 10 is a cross-sectional view of the ignition coil shown in FIG. 9 cut along line X-X;

FIG. 11 is a cross-sectional longitudinal view of an ignition coil according to the third embodiment of the invention;

FIG. 12 is a plan view of the ignition coil shown in FIG. 11 viewed from a position indicated by arrows XII-XII;

FIG. 13 is a cross-sectional longitudinal schematic diagram of a center core of the ignition coil according to the third embodiment;

FIG. 14 is a plan view of the center core shown in FIG. 12 cut viewed from a position indicated by arrows XIV-XIV;

FIG. 15 is a cross-sectional longitudinal view of a main portion of an ignition coil according to the fourth embodiment of the invention;

FIG. 16 is a schematic diagram of the center core of the ignition coil shown in FIG. 15;

FIGS. 17A, 17B and 17C illustrate steps of forming a cylindrical center core to be used in the ignition coil shown in FIG. 15;

FIG. 18 is a schematic diagram of the center core of an ignition coil according to the fifth embodiment of the invention;

FIG. 19 is a cross-sectional longitudinal view of a main portion of an ignition coil according to the sixth embodiment of the invention;

FIG. 20 is a schematic side view of an outer core and a center core of an ignition coil according to the seventh embodiment of the invention; and

FIG. 21 is an enlarged cross-sectional view of a modified embodiment of the ignition coil shown in FIG. 1.

### DETAILED DESCRIPTION OF THE PREFERRED EMBODIMENTS

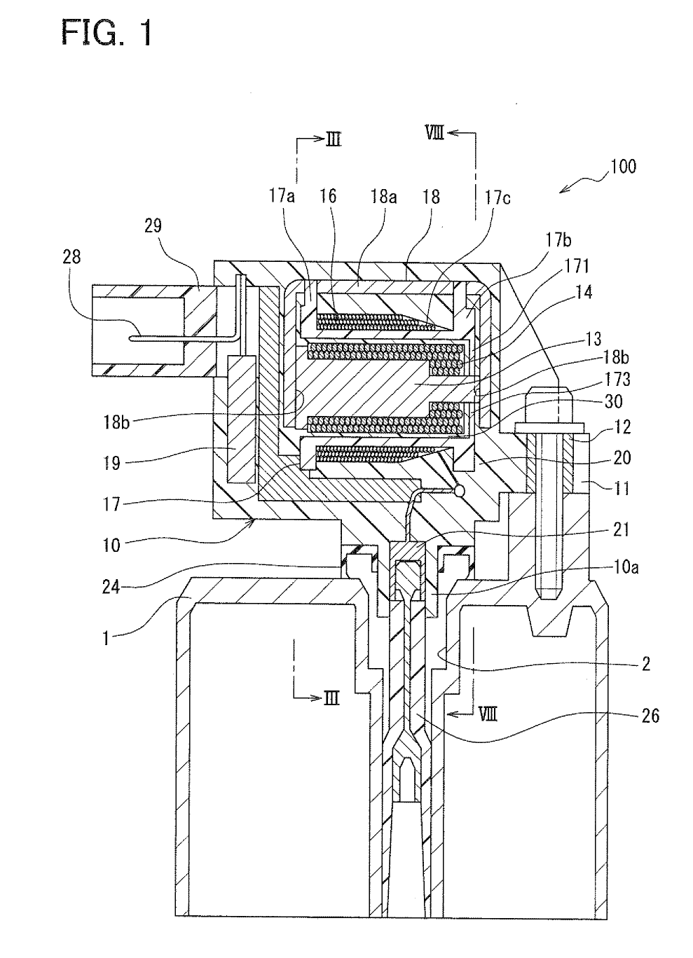

An ignition coil 100 according to the first embodiment of the present invention will be described with reference to FIGS. 1-8.

As shown in FIG. 1, the ignition coil 100 includes a generally cubic mold unit 10 that is disposed outside a plug hole 2 of an engine head. The mold unit 10 includes a generally stepped cylindrical center core 13, a primary coil 14, a secondary coil 16, a secondary-coil spool member 17, an outer core 18, an igniter 19, an insulating resinous mold 20, etc.

The mold unit 10 also has a side wall from which a stay portion 11 extends outward. A metal bush 12 is inserted in the stay portion 11 so that the mold unit 10 can be tightly fixed to an engine head 1 at the stay portion 11 by a through bolt 12a. The mold unit 10 has another side wall from which a connector portion 29 projects. A terminal member 28 projects outward from the inside of the connector portion to connect the igniter 19 to an outside control unit such as an engine control unit (not shown).

The mold unit 10 also has a bottom wall from which a tower portion 10a projects downward. A high voltage terminal 21 is inserted in the tower portion 10a so as to connect with the output end of the secondary coil 16. A pole 26, which is made of resinous material such as PBT (polybutylene terephthalate), PPS (polyphenylene sulfide) or unsaturated polyester resin, is fitted to the inside wall of the tower portion 10a at one end thereof and inserted into the plug hole 2 at the other end to be coaxial therewith. A rubber seal member 24 is interposed between the tower portion 10a and the engine head 1 so as to water-tightly seal the opening of the plug hole 24.

An engine control unit (not shown) sends a signal and electric power to the igniter 19 via the terminal 28 of the connector 29. When a control unit sends the signal, current flowing in the primary coil 14 is cut, so that a high voltage of about 30 or 35 K volts is generated at the secondary coil 16 due to the mutual inductance of the primary coil 14 and the secondary coil 16. The high voltage is given to a spark plug (not shown) via the high voltage terminal 21 and a conductive spring (not shown), providing spark discharge at the spark plug.

The center core 13 is disposed in the mold unit 10 to be perpendicular to the longitudinal direction of the plug hole 2. The center core 13 is made of a compressed powder of magnetic material such as cobalt, nickel, or alloy of cobalt and nickel. The compressed powder of magnetic material is press-formed under such a pressure of 5-20 tons that not only ensures a sufficient magnetic permeability for the ignition coil 100 but also eliminates sharp edges from the outside surface thereof.

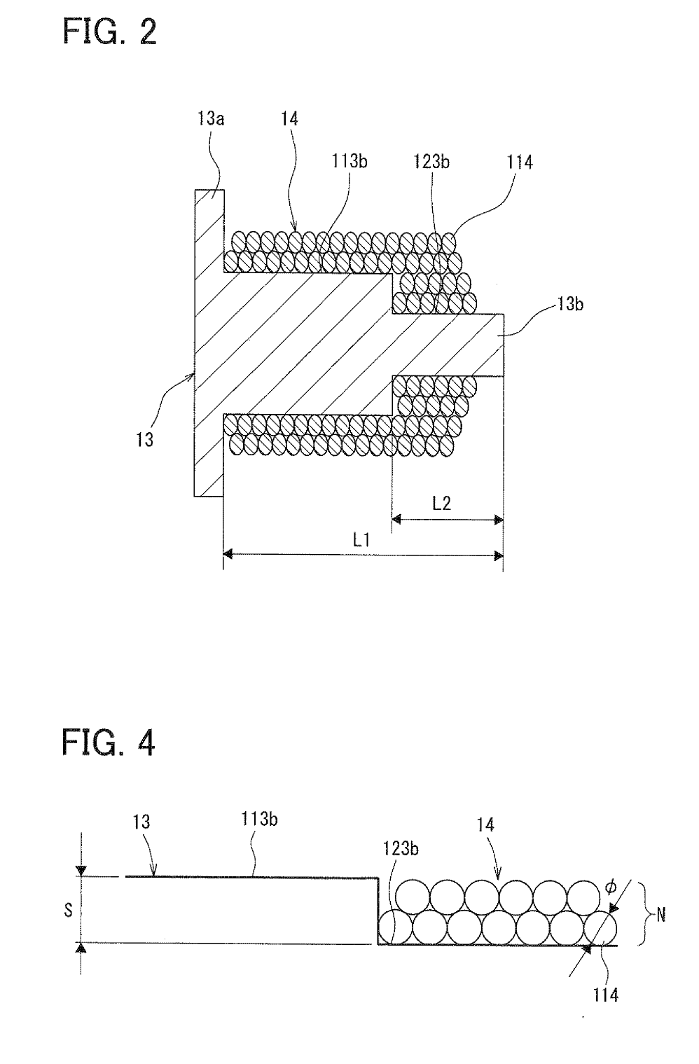

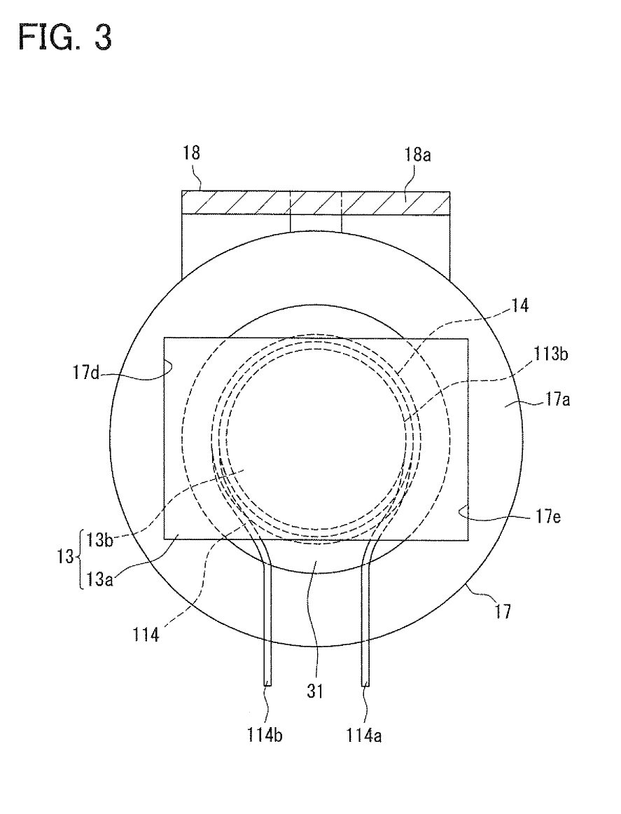

As shown in FIG. 2, the center core 13 has a flange portion 13a and a spool portion 13b. The flange portion 13a is formed at an end of the center core 13 as a stopper to prevent the primary coil 14 from falling down. The flange portion 13a is shaped into a rectangular plate to have a diametrical size larger than the outside diameter of the primary coil 14, as shown in FIG. 3.

The spool portion 13b is constructed of two cylindrical portions of different outside diameters—a first cylindrical portion 113b that has a cross-section sufficient for accommodating magnetic flux generated by the primary coil 14 and a second cylindrical portion 123b that is smaller in diameter than the first cylindrical portion 113b to provide a sufficient space for accommodating a portion of the primary coil 14.

In order to accommodate sufficient magnetic energy in the spool portion 13b, the length L2 of the second cylindrical portion 123b is preferably less than 50%, preferably 40%, of the whole length L1 of the spool portion 13b. For example, the whole length L2 is 31.6 mm, while the length L2 is 13.2 mm.

As shown in FIG. 4, there is a step difference S between the first cylindrical portion 113b and the second cylindrical portion 123b. The step difference S and a difference ΔN in the number of turns of the primary coil between the first cylindrical portion 113b and the second cylindrical portion 123b have the following relation.

S≧Φ×ΔN×C, wherein: Φ is an outside diameter of an insulated electric wire of the primary coil; and C is a diameter reduction ratio of the insulated electric wire that is wound around the spool portion 13b under a prescribed winding tension.

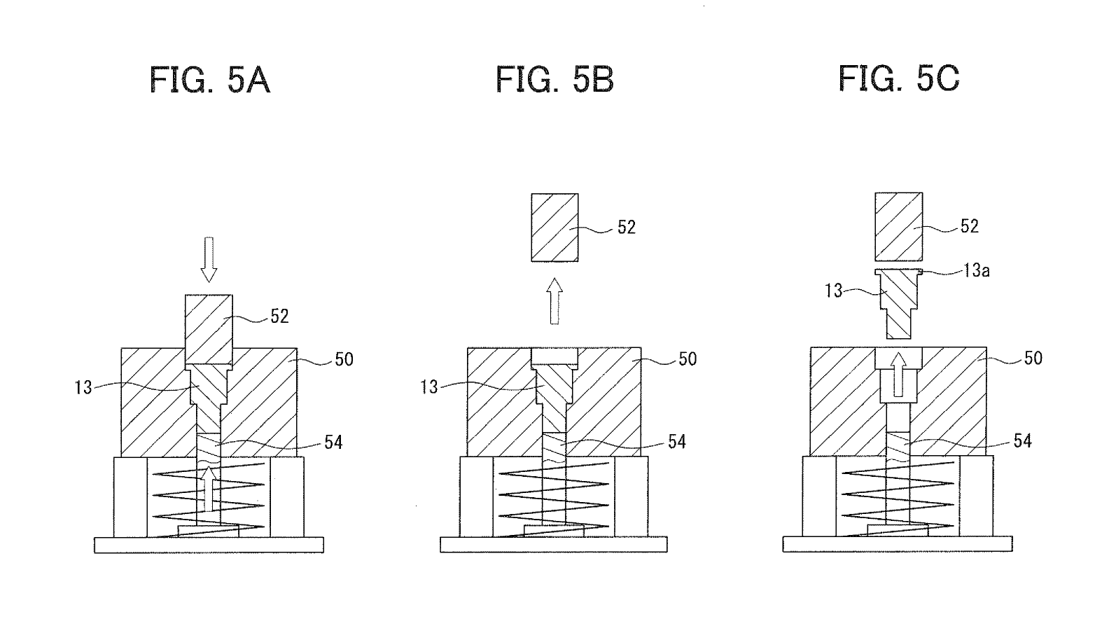

The center core 13 is manufactured as shown in FIGS. 5A, 5b and 5C.

At first, a prescribed amount of magnetic powder is filled into a mold die 50 and compressed by an upper punch 52 and lower punch 54 under a prescribed pressure such as 5-20 tons and temperature such as 100-150° C. for a prescribed time period, as shown in FIG. 5A. Before the magnetic powder is filled into the mold die 50, die lubricant may be applied to the inside of the mold die 50 to keep the shape of the center core in good conditions.

Thereafter, the upper punch 52 is pulled out from the mold die as shown in FIG. 5B, and the compressed center core 13 is unloaded from the mold die 50, as shown in FIG. 5C.

As shown in FIG. 2, an insulated electric wire (enamel wire) 114 of 0.5 mm in diameter is directly wound around the first cylindrical portion 113b from the left end (on the flange portion side) of the first cylindrical portion 113b to the right end thereof and, then directly wound around the second cylindrical portion 123b from the left end to the right end thereof, thereby forming a first layer of the primary coil 14. Then, the insulated electric wire 114 is wound around the second cylindrical portion 123b to form four layers at the second cylindrical portion 123b. Finally, the insulated electric wire 114 is wound from the fourth layer of the second cylindrical portion to form the second layer of the insulated electric wire 114 around the first layer at the first cylindrical portion 113b so that the number of turns of the primary coil 13 becomes 120. As a result, the primary coil 14 has a first coil portion of two layers at the first cylindrical portion 113a and a second coil portion of four layers at the second cylindrical portion 123b. However, the first coil portion of the primary coil may have an even number of layers other than two layers, and the second coil portion may have an even number of layers other than four layers. The number of layers at the second cylindrical portion 123b may be increased if more electro-magnetic energy is necessary, as long as the maximum outside diameter of the secondary coil 16 does not increase. Incidentally, the difference ΔN in the number of turns of the primary coil between the first cylindrical portion 113b and the second cylindrical portion 123b is two (2), in this case. Thus, the spool member for the primary coil can be omitted and a compact and inexpensive ignition coil can be provided.

As shown in FIG. 3, opposite (starting and cut) ends 114a, 114b of the primary coil 14 are drawn from the first cylindrical portion 113b on the side of the flange portion 13a, so that electric connection can be carried out easily.

Incidentally, the outside diameter and the number of turns of the insulated electric wire 114 for the primary coil 14 may be respectively 0.3 mm-0.8 mm and 100-230. It has been found more preferable that the outside diameter is 0.5 mm, and the number of turns is 120.

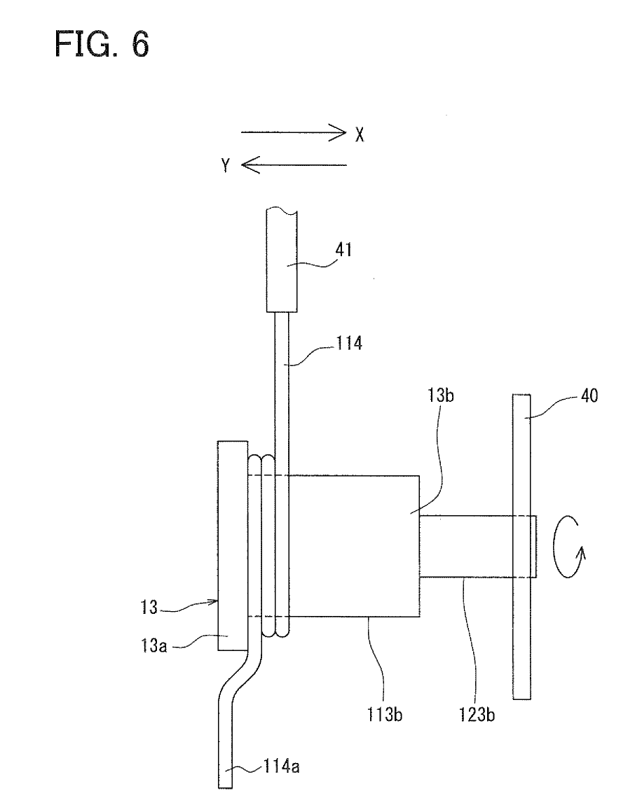

Now, a method of manufacturing the primary coil will be described below with reference to FIGS. 6-8.

Before winding of the insulated electric wire 114 around the spool portion 13a, a disk member 40 is attached to the right end of the center core 13 that is opposite the flange portion 13a. Then, the starting end 114a of the insulated electric wire 114 is extended through a winding nozzle 41 to be wound around the left end of the first cylindrical portion 113b. Thereafter, the center core 13 is turned at a constant speed while the insulated electric wire 114 is fed from the winding nozzle 41 under a suitable tension. Consequently, the nozzle 41 is moved along a longitudinal direction X at a suitable speed so that the insulated electric wire 114 can be continuously wound around the cylindrical portions 113b and 123b to form the first layer of the insulated electric wire 114 around the center core 13.

When the first layer of the primary coil 13 reaches the disk member 40, the winding nozzle 41 U-turns and moves along the other direction Y at the second cylindrical portion 123b. Accordingly, the insulated electric wire 114 is wound on the first layer of the insulated electric wire 114 to form the second layer at the second cylindrical portion 123b. The insulated electric wire 114 of the second layer is wound around portions between two lines of the insulated electric wire 114 of the first layer, so that the second layer of the insulated electric wire 114 can be prevented from shifting in the longitudinal directions of the center core 13.

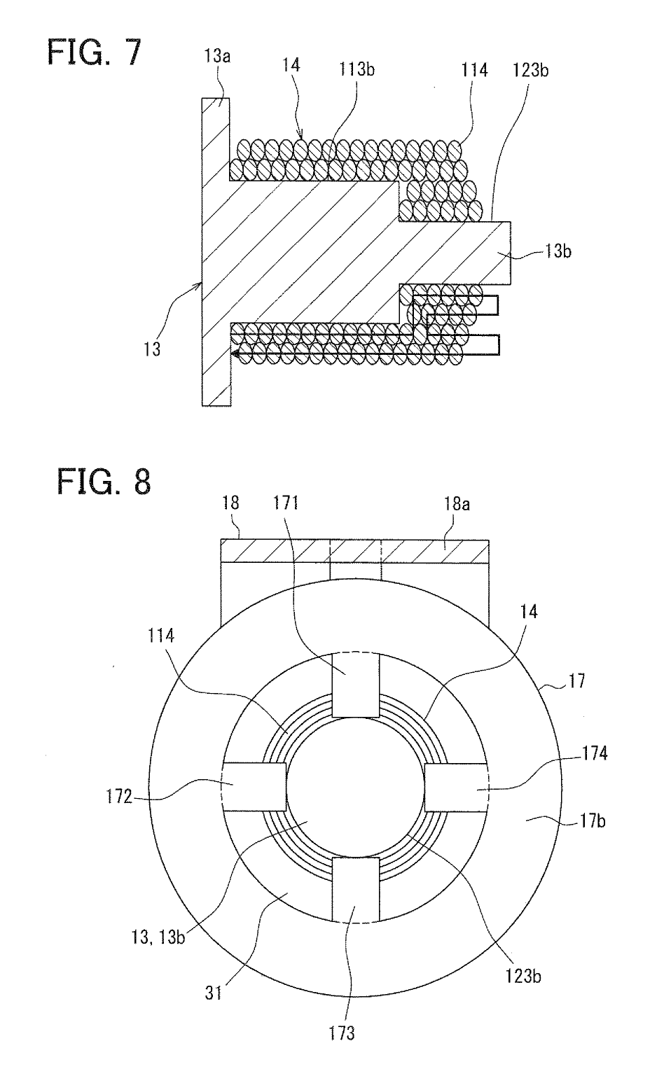

When the insulated electric wire 114 of the second layer reaches the left end of the second cylindrical portion 123b adjacent to the first cylindrical portion 113b, the nozzle 41 makes a U-turn to again move in the X direction. Therefore, a third layer is formed on the second layer at the second cylindrical portion 123b. As shown in FIG. 7, the outside diameter of the third layer at the second cylindrical portion 123b is approximately the same as the outside diameter of the first layer at the first cylindrical portion 113b. Incidentally, the step difference S provides a wall that functions to prevent the insulated electric wire from shifting in longitudinal directions of the center core 13.

When the insulated electric wire of the third layer reaches the right end of the second cylindrical portion 123b adjacent to the disk member 40, the nozzle 41 makes another U-turn to again move in the Y direction. Accordingly, the insulated electric wire 114 is wound on the third layer at the second cylindrical portion 123b to form a fourth layer, and continuously wound around the first layer of the first cylindrical portion to form a second layer of the first cylindrical portion 113b.

When the insulated electric wire 114 reaches the left end of the first cylindrical portion 113b adjacent to the flange portion 13a, feeding of the insulated electric wire 114 from the nozzle 41 is stopped, and the insulated electric wire 114 is cut to form a cut end 114b of the primary coil 13, which is drawn outward from the portion between the left end of the spool portion 13b and the flange portion 13a. Thereafter, the disk member 40 is taken off from the center core 13.

Incidentally, the starting end 114a of the insulated electric wire 114 may be extended through a winding nozzle 41 to be wound around the right end of the second cylindrical portion 113b. In this case, the insulated electric wire 114 is cut to form a cut end 114b of the primary coil 13 and drawn outward from the portion between the right end of the spool portion 13b and the disk member 40 so as to locate both ends 114a, 114b at the right end of the spool portion 13b.

The secondary-coil spool member 17 is made of a resinous cylindrical member, as shown in FIG. 1. The secondary-coil spool member 17 has disk-like flange portions 17a, 17b respectively formed at opposite ends thereof and a cylindrical portion 17c between the flange portions 17a, 17b. The secondary-coil spool member 17 surrounds the spool portion 13b and the primary coil 14.

As shown in FIG. 3, the flange portion 17a is located around the flange portion 13a of the center core 13 and has a rectangular groove having opposite sides 17d, 17e, to which the longitudinally opposite sides of the flange portion 13a of the center core 13 fit. Therefore, the center core 13 can be fixed in a prescribed position easily and accurately.

As shown in FIG. 8, the secondary-coil spool member 17 has a cylindrical inside surface, from which four projection members 171, 172, 173, 174 project inward so as to contact with the end of the center core 13. The projection members 171, 172, 173, 174 are circumferentially spaced apart from each other at an angle of 90°, thereby adjusting the spool member 17 to be coaxial with the center core 13.

Therefore, a cylindrical space 30 (shown in FIG. 1) to be filled with resinous insulating material is formed between the secondary-coil spool member 17 and the outer periphery of the primary coil 14. As shown in FIG. 8, the cylindrical space 30 (shown in FIG. 1) communicates with axially opposite sides of the secondary-coil spool member 17 through arc-shaped openings 31.

The secondary coil 16 that is wound around the cylindrical portion 17c has a cylindrical shape and is molded into the mold unit 10 with the secondary-coil spool member 17. Incidentally, the secondary coil 16 is formed of an insulated electric wire of a diameter of 40 μm-50 μm that is wound (e.g. diagonally) around the secondary-coil spool member 17 to have 10,000-20,000 turns.

The outer core 18 is made of a rectangular cup-shaped magnetic member with the opening facing the engine head 1, as shown in FIG. 1. The outer core 18 is also molded into the mold unit 10. The outer core 18 has a rectangular bottom 18a and four side walls 18b that extend perpendicularly to the bottom 18a. The distance between the side walls 18b that confront each other in the longitudinal direction of the center core 13 is about the same as the length of the center core 13, so that the outer core 18 can support the center core 13 between the side walls 18b. The above distance provides longitudinal spaces between each of the two side walls 18b and the secondary-coil spool member 17. The bottom 18a of the outer core 18 is supported by edges of the flange portions 17a, 17b so as to keep the distance between the bottom 18a and the secondary-coil spool member 17.

The starting end 114a of the primary coil 14 and the cut end 114b thereof extend from one of the openings 31 to be connected to the igniter 19. The outer core 18 is electrically connected to an earth bar (not shown).

The center core 13, the primary coil 14, the secondary coil 16, the secondary-coil spool member 17, the outer core 18 and the igniter 19 are insert-molded with resinous material 20, such as thermoset resin, into the mold unit 10. The resinous material 20, which is in a liquid state, is infused through the openings 31 to fill the space 30 and spaces among the above components and insulates the secondary coil 16 from the outside thereof, the outer core 18 and others.

Because the center core that has stepped cylindrical portions whose outside diameter is smaller than the main portion thereof, the center core can accommodate more layers of insulated electric wires to form a primary coil than a conventional one. Therefore, necessary magnetic performance of the ignition coil can be ensured,

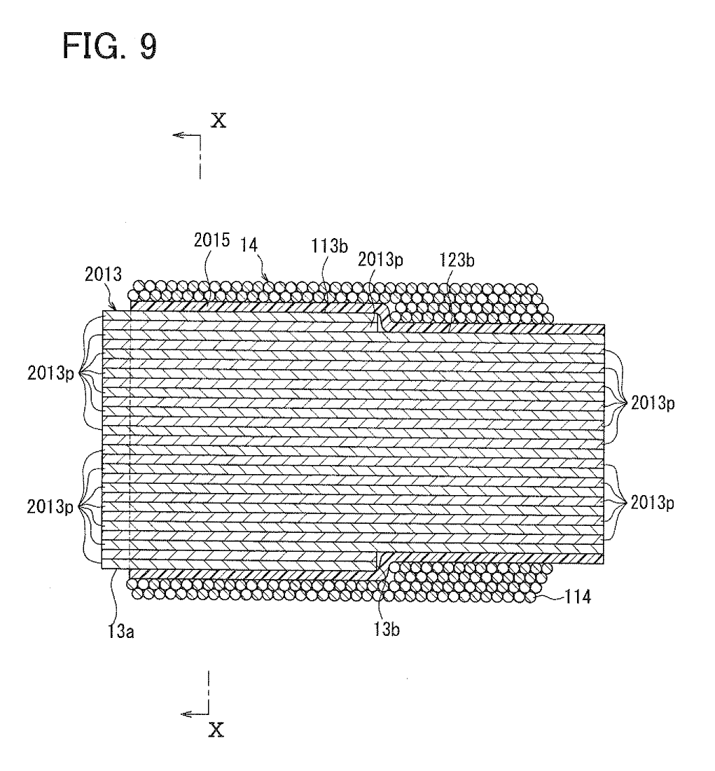

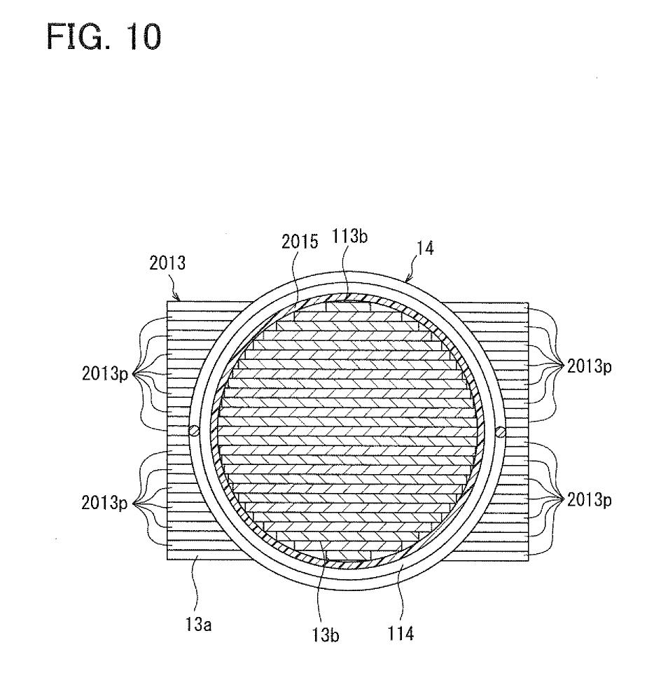

An ignition coil according to the second embodiment of the present invention will be described with reference to FIGS. 9 and 10.

Incidentally, the same reference numeral indicates the same or substantially the same part, portion or component as the first or an embodiment that is previously described hereafter.

The ignition coil according to the second embodiment includes a generally cylindrical and stepped center core 2013, a primary coil 14, a secondary coil, a secondary-coil spool member, an outer core, an igniter, an insulating resinous mold, etc. The stepped center core 2013 is a laminate of plural magnetic steel sheets 2013p, each of which has a thickness of 0.27 mm, although the thickness may be all right if it is 0.2-1 mm. The center core 2013 has a rectangular flange portion 13a, a first cylindrical portion 113b and a second cylindrical portion 123b, as the first embodiment shown in FIG. 2. The whole outer surface of the laminate is covered with a thin film 2015 of insulating material such as a heat shrinkable tube made of polyolefin, polyvinyl chloride, or polyvinyliden fluoride. Therefore, the primary coil 14 is insulated by the thin film 2015 from the center core 2013.

Because the center core that has stepped cylindrical portions whose outside diameter is smaller than the main portion thereof, the center core can accommodate more layers of insulated electric wires to form a primary coil than a conventional one. Therefore, necessary magnetic performance of the ignition coil can be ensured.

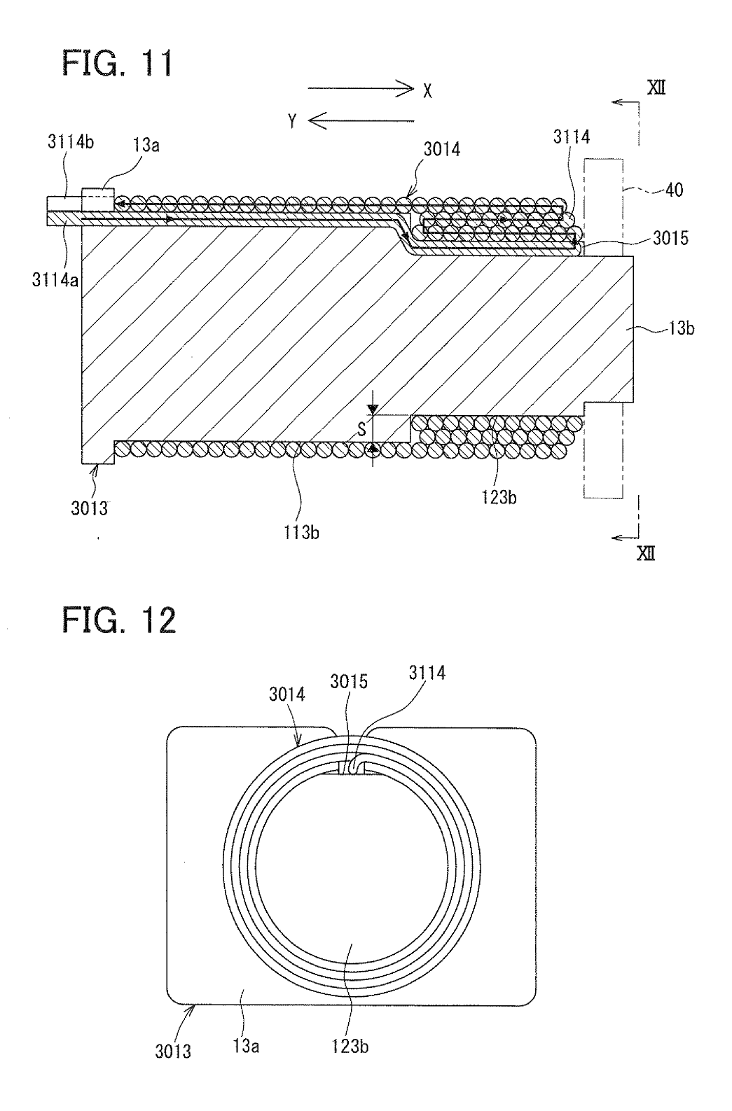

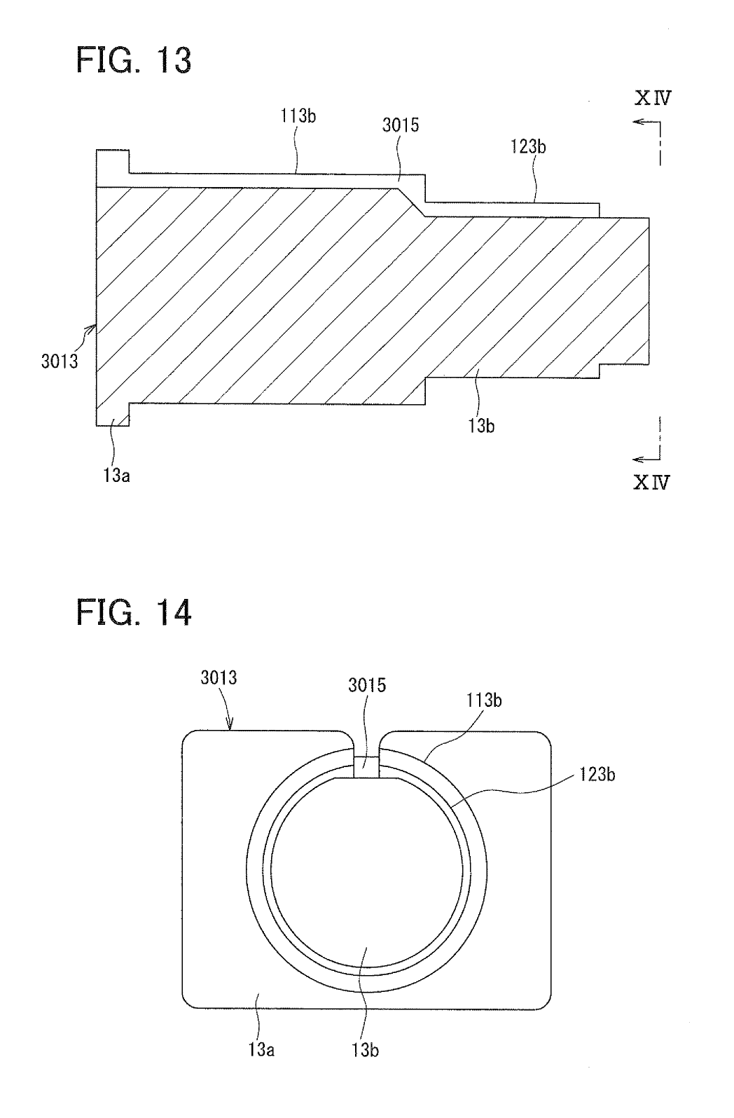

An ignition coil according to the third embodiment of the present invention will be described with reference to FIGS. 11-14.

The ignition coil according to the third embodiment includes a generally stepped cylindrical center core 3013, a primary coil 3014, a secondary coil, a secondary-coil spool member, an outer core, an igniter, an insulating resinous mold, etc.

The stepped center core 3013 is made of a compressed powder of magnetic material such as cobalt, nickel, or alloy of cobalt and nickel in the same manner as the first embodiment and formed to have a flange portion 13a at one end of the center core 3013, a first cylindrical portion 113b and a second cylindrical portion 123b. A longitudinal groove 3015 is also formed to extend from the flange portion 13a to the other end thereof via the first cylindrical portion 113b and the second cylindrical portion 123b.

As shown in FIGS. 11 and 12, the primary coil 3014 has an odd number of winding layers disposed at both the first cylindrical portion 113b and the second cylindrical portion 123b. That is, the primary coil 3014 has a first coil portion of one layer of an insulated electric wire 3114 at the first cylindrical portion 113a and a second coil portion of three layers of the same insulated electric wire 3114 at the second cylindrical portion 123b. Therefore, the difference ΔN in the number of turns is 2, and the step difference S is set according to the expression: S≧Φ×ΔN×C.

The starting end 3114a of the insulated electric wire 3114 is extended from the flange portion 13a formed at one end of the center core 13 along the longitudinal groove 3015 to the other end of the center core 13 to be wound around the second cylindrical portion 123b, so that the starting end 3114a and the cut end 3114b can be drawn to the same left end of the center core 13, as shown in FIG. 11. Therefore, connection of the primary coil 3014 with the igniter 19 can be made easy.

The primary coil 3014 is manufactured as follows.

Before winding of the insulated electric wire 3114 around the center core 13, a disc member 40 is attached to the end of the center core 13 that is formed opposite the flange portion 13a. Then, the starting end 3114a of the insulated electric wire 3114 is extended from the side of the flange portion 13a along the groove 3015 via the first and second cylindrical portions 113b, 123b toward the disk member 40. When the starting end reaches the disk member 40, the insulated electric wire 3114 is wound around the second cylindrical portion. Thereafter, the center core 13 is turned at a constant speed while the insulated electric wire 3114 is fed from the winding nozzle 41 under a suitable tension, with the nozzle 41 being moved along a longitudinal direction Y at a suitable speed so that the insulated electric wire 3114 can be continuously wound around the cylindrical portions 113b and 123b to form the first layer of the insulated electric wire 3114 around the center core 13.

When the insulated electric wire 3114 reaches the left end of the second cylindrical portion 123b adjacent to right end of the first cylindrical portion 113b, the winding nozzle makes a U-turn to move in the X-direction while the rotation speed of the center core 3013 is kept constant. Therefore, the second layer of the insulated electric wire 3114 is formed on the first layer of the insulated electric wire 3114 the second cylindrical portion 123b, so that the outside diameter of the second layer becomes approximately the same as the outside diameter of the first cylindrical portion 113b. Incidentally, the step difference S provides a wall that functions to prevent the insulated electric wire from shifting in longitudinal directions of the center core 13.

When the insulated electric wire 3114 has reached the disk member 40 to form the second layer of the second cylindrical portion 123b, the nozzle 41 makes another U-turn to move in the Y-direction while the rotation speed of the center core 3013 is kept constant. Therefore, the insulated electric wire 3114 is wound on the second layer of the second cylindrical portion to form a third layer of the second cylindrical portion 123b and, thereafter around the first cylindrical portion 113b to form a first layer of the first cylindrical portion 113b.

When the insulated electric wire 3114 reaches the flange portion 13a, the insulated electric wire 3114 is cut so that a cut end 3114b is drawn out through the flange portion 13a. Thereafter, the disk member 40 is taken off from the center core 13. At this moment, the flange portion and the portion where the step difference is formed to function as a stopper to prevent the primary coil 3014 from collapsing. It is also possible to draw both the starting end and cut end from the right end, which is opposite the flange portion if the starting end is extended from the right end along the groove 3015 to the flange portion 13a of the left end to be wound in the same manner as the first embodiment.

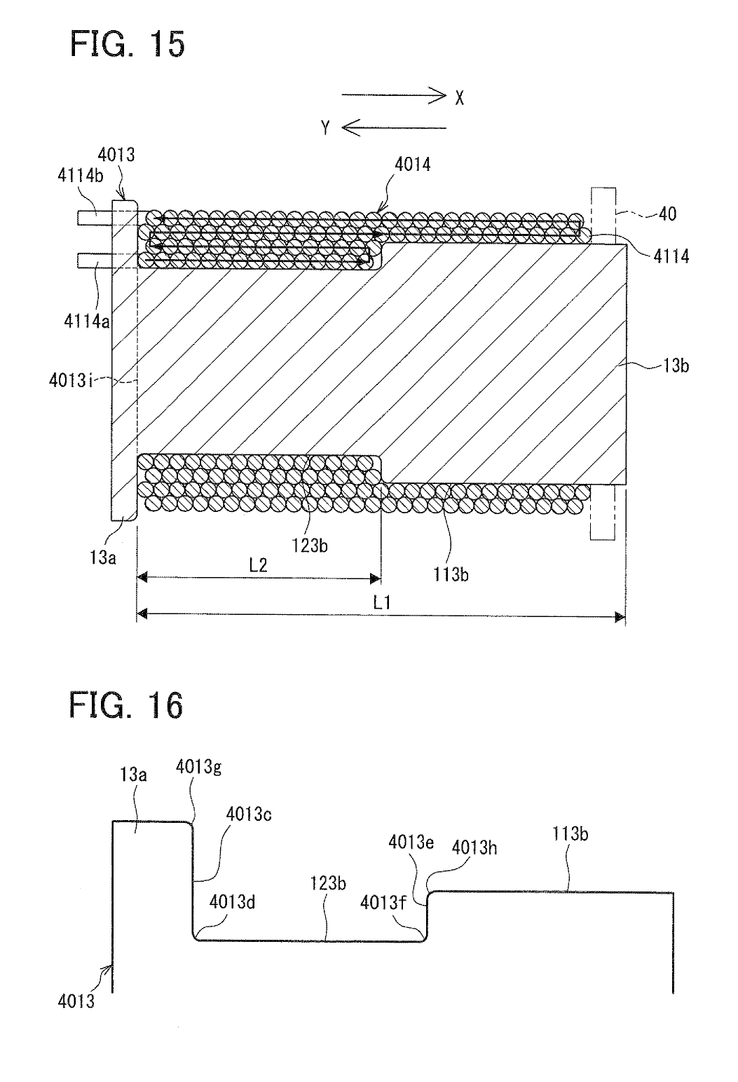

An ignition coil according to the fourth embodiment of the present invention will be described with reference to FIGS. 15, 16 and 17A-17C.

The ignition coil according to the fourth embodiment has a center core 4013 made of compressed magnetic material. The center core 4013 also has a flange portion 13a, a first cylindrical portion 113b and a second cylindrical portion 123b. However, the second cylindrical portion 123b whose outside diameter is smaller than the first cylindrical portion 113b is located between the flange portion 13a and the first cylindrical portion 113b.

The length L2 of the second cylindrical portion is equal to or 50% less than the total length L1 of the center core 4013. Here, L1 is 31.6 mm, L2 is 15.4 mm and L2/L1 is 48.7%.

As shown in FIG. 16, the center core 4013, each of concave corners 4013d, 4013f and convex comers 4013g and 4013h of the first and the second cylindrical portions is rounded. Each of the concave comers 4013d, 4013f formed in the second cylindrical portion 123b has a radius of about 0.2 mm, the convex corner 4013g on the flange portion 13a adjacent to the second cylindrical portion 123b has a radius of about 0.5 mm, the convex corner 4013h of the first cylindrical portion 113b adjacent to the second cylindrical portion 123b has a radius of about 0.3 mm.

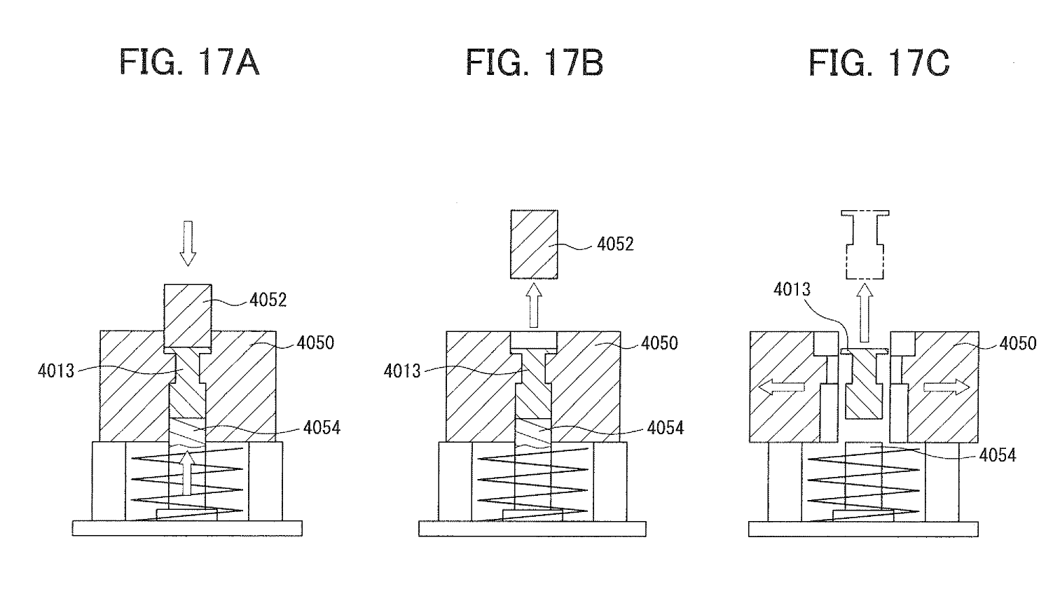

The center core 4013 is manufactured as shown in FIGS. 17A-17C.

At first, a prescribed amount of magnetic powder is filled into a divided type mold die 4050 and compressed by an upper punch 4052 and lower punch 4054 under a prescribed pressure, as shown in FIG. 17A.

Thereafter, the upper punch 4052 is pulled out from the mold die as show in FIG. 5B, and the divided type mold die 4050 is opened in the direction perpendicular to the axis of the compressed center core 13, which is then unloaded from the mold die 4050, as shown in FIG. 17C. Before the magnetic powder is filled into the mold die 4050, die lubricant may be applied to the inside of the mold die 4050 to keep the shape of the center core in good conditions.

As shown in FIG. 15, the insulated electric wire 4114 is wound around the first cylindrical portion 1113b into two layers and the second cylindrical portion 123b into four layers. Both the starting end 4114a and the cut end 4114b of the insulated electric wire 4114 are drawn out from the portion of the second cylindrical portion 123b adjacent to the flange portion 13a. The rounded corners 4013d, 4013f, 4013g and 4013h prevent the insulated electric wire from breaking.

The primary coil 4014 is manufactured as shown in FIG. 15. At first a disk member 40 is attached to the end of the center core 4013 that is formed opposite the flange portion 13a. Then, the starting end 4114a of the insulated electric wire 4114 is extended through a winding nozzle 41 to be wound around the left end of the second cylindrical portion 113b. Thereafter, the center core 4113 is turned at a constant speed while the insulated electric wire 4114 is fed from the winding nozzle 41 under a suitable tension. Consequently, the nozzle 41 is moved along a longitudinal direction X at a suitable speed so that the insulated electric wire 4114 can be continuously wound around the second cylindrical portions 113b to form the first layer of the insulated electric wire 4114 around the second cylindrical portion.

When the first layer of the insulated electric wire 4114 reaches a wall formed by a step difference S at portion of the second cylindrical portion adjacent to the first cylindrical portion 113b, the winding nozzle 41 U-turns and moves along the other direction Y at the second cylindrical portion 123b. Accordingly, the insulated electric wire 4114 is wound on the first layer of the insulated electric wire 4114 to form the second layer at the second cylindrical portion 123b. The outside diameter of the second layer becomes approximately equal to the outside diameter of the first cylindrical portion. Incidentally, the flange portion 13a and the wall function to prevent the insulated electric wire from shifting in longitudinal directions of the center core 13. When the insulated electric wire 4114 of the second layer reaches the left end of the second cylindrical portion 123b adjacent to the flange portion 13a, the nozzle 41 makes a U-turn to again move in the X direction. Therefore, a third layer is formed on the second layer at the second cylindrical portion 123b and a first layer is formed on the surface of the first cylindrical portion 113b.

When the insulated electric wire 4114 of the first cylindrical portion reaches the portion of the first cylindrical portion adjacent to the disk member 40, the winding nozzle 41 U-turns and moves along the other direction Y at the first cylindrical portion 123b. Accordingly, the insulated electric wire 4114 is wound on the first layer of the insulated electric wire 4114 to form the second layer at the first cylindrical portion 113b and on the third layer at the second cylindrical portion 123b to form the fourth layer of the insulated electric wire 4114.

When the insulated electric wire 4114 reaches the flange portion 13a, the insulated electric wire 4114 is cut so that a cut end 4114b is drawn out through the flange portion 13a. Thereafter, the disk member 40 is taken off from the center core 13. At this moment, the flange portion 13b and the portion where the step difference is formed function as a stopper to prevent the primary coil 4014 from collapsing.

It is also possible to draw both the starting end and cut end from the right end of the center core 4013, which is opposite the flange portion if the starting end is extended from the right end of the center core 4013 along the groove 3015 to the flange portion 13a of the left end of the center core 4013 to be wound in the same manner as the first embodiment.

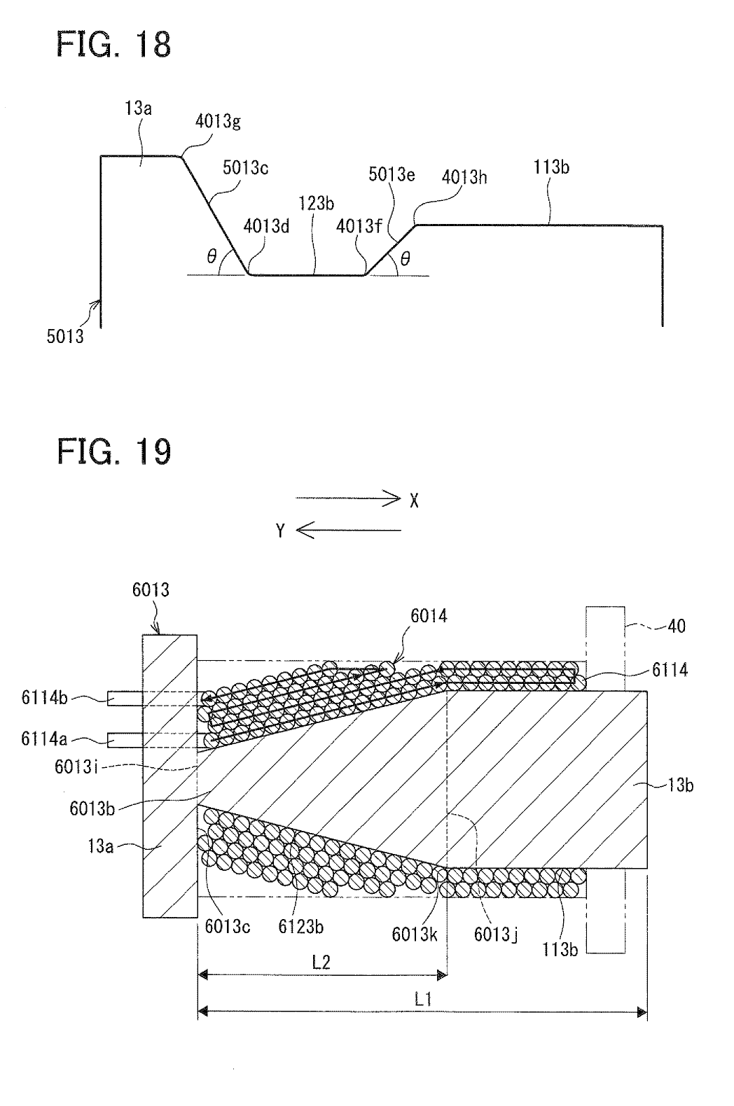

An ignition coil according to the fifth embodiment of the present invention will be described with reference to FIG. 18.

The ignition coil according to the fifth embodiment has a center core 5013 made of compressed magnetic material. The center core 4013 also has a flange portion 13a, a first cylindrical portion 113b and a second cylindrical portion 123b. The second cylindrical portion 123b whose outside diameter is smaller than the first cylindrical portion 113b is located between the flange portion 13a and the first cylindrical portion 113b. The second cylindrical portion 123b has tapering walls 5013c and 5013e at its opposite ends that merge the cylindrical surface at angle of θ, as shown in FIG. 18.

Other portions of the center core and the method of manufacturing the same are almost the same as the center core 4013 of the ignition coil according to the fourth embodiment.

An ignition coil according to the sixth embodiment of the present invention will be described with reference to FIG. 19. The ignition coil according to the sixth embodiment is almost the same as the fourth embodiment except for the second cylindrical portion 123b. The center core 6013 has a flange portion 13a, a first cylindrical portion 113 and a tapering portion 6123b, which tapers off toward the flange portion 13a, instead of the second cylindrical portion 123b. In other words, the tapering portion has one end that is formed adjacent to the flange portion 13a and the other end that is formed adjacent to the first cylindrical portion. The one end forms a wall 6013c with the flange portion 13a, and the other end connects with the first cylindrical portion 113b at an interface 6013k without step difference or a wall.

In order to provide sufficient magnetic energy in the spool portion 13b, the length L2 of the tapering portion 6123b is preferably less than 50%, preferably 40%, of the whole length L1 of the spool portion 13b. Because the outside diameter of the tapering portion gradually changes, reduction in magnetic performance due to magnetic saturation of the center core 6013 can be effectively prevented.

A primary coil 6014 of the ignition coil according to the sixth embodiment includes four layers of insulated electric wire 6014 wound around the tapering portion 6123b and two layers of the insulated electric wire 6014 wound around the first cylindrical portion 113b. The primary coil 6014 has a starting end 6114a and a cut end 6114b that are drawn from an end of the tapering portion 6123b adjacent to the flange portion 13a.

The primary coil 6014 is manufactured as follows. At first, a disk member 40 is attached to the end of the center core 6013 that is formed opposite the flange portion 13a. Then, the starting end 6114a of the insulated electric wire 6114 is extended from the left end of the tapering portion 6123b. Thereafter, the center core 6113 is turned at a constant speed while the insulated electric wire 6114 is fed from the winding nozzle 41 under a suitable tension. Consequently, the nozzle 41 is moved along a longitudinal direction X at a suitable speed so that the insulated electric wire 6114 can be continuously wound around the tapering portion 6123b and the first cylindrical portion 113b to form the first layer of the insulated electric wire 6114.

When the first layer of the insulated electric wire 6114 reaches the disk portion 41, the winding nozzle 41 U-turns and moves in the other direction Y at the second cylindrical portion 123b while the center core is turned at the same speed. Accordingly, the insulated electric wire 6114 is wound on the first layer of the insulated electric wire 6114 to form the second layer at the first cylindrical portion 113b and the tapering portion 6123b.

When the insulated electric wire 6114 of the second layer reaches the left end of the tapering portion 6123b adjacent to the flange portion 13a, the nozzle 41 makes a U-turn to again move in the X direction. Therefore, a third layer is formed on the second layer at the tapering portion 6123b. When the outside diameter of the third layer becomes equal to the outside diameter of the second layer formed at the first cylindrical portion 113b, the nozzle makes another U-turn to move in the Y-direction while the center core is turned at the same speed. Therefore, a fourth layer is formed on the third layer at the tapering portion 6123b.

When the insulated electric wire 6114 reaches the flange portion 13a, the insulated electric wire 6114 is cut so that a cut end 6114b is drawn out through the flange portion 13a. Thereafter, the disk member 40 is taken off from the center core 13. At this moment, the flange portion 13b and the portion where the step difference is formed function as a stopper to prevent the primary coil 6014 from collapsing.

Incidentally, the starting end 6114a of the insulated electric wire 6114 may be extended through a winding nozzle 41 to be wound around the right end of the first cylindrical portion 113b. In this case, the insulated electric wire 114 is cut to form a cut end 6114b of the primary coil 13 and drawn outward from the portion between the right end of the spool portion 13b and the disk member 40 so as to locate both ends 6114a, 6114b at the right end of the spool portion 13b.

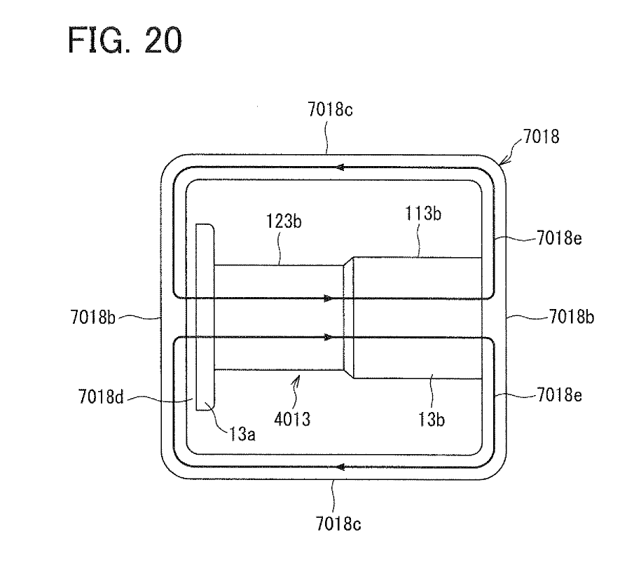

An ignition coil according to the seventh embodiment of the present invention will be described with reference to FIG. 20.

The ignition coil according to the seventh embodiment has the same center core 4013 as that of the fourth embodiment and a frame like rectangular outer core 7018 that surrounds the center core 4013. The outer core 7018 has a first pair of side members 7018b that extends perpendicular to the center core 4013 and a second pair of side members 7018c that extends in parallel to the center core 4013 to connect the pair of side members 7018. There is a air gap 7018d of about 0.1-0.6 mm between one end of the center core 4013 and one of the first pair of side members 7018b.

That is, a pair of magnetic paths 7018c that includes the center core 4013 is provided by the outer core 7018, as shown in FIG. 20. When primary current is supplied to the primary coil 4014 that is wound around the center core 4013, the magnetic flux density in a portion of the center core becomes smaller as the portion nears the air gap 7018d. Therefore, magnetic saturation in the second cylindrical portion 123b can be moderated.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims.

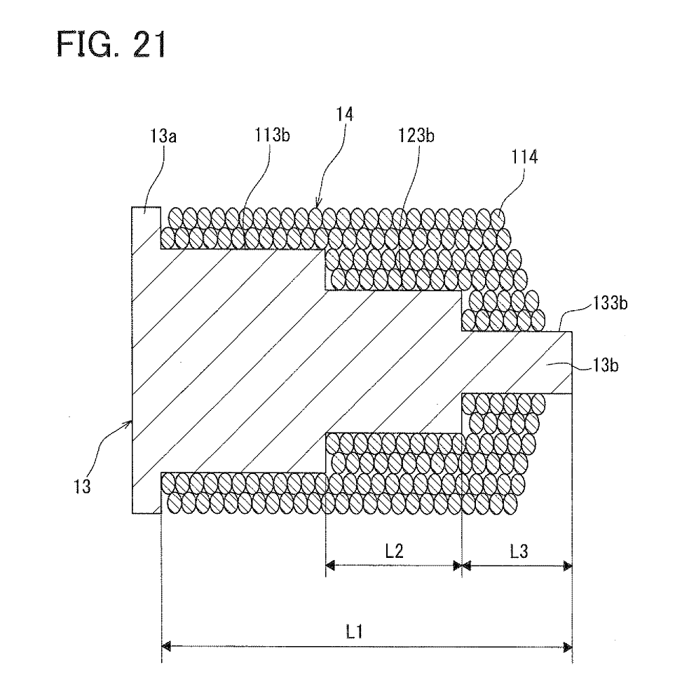

For example: a third cylindrical portion 133b can be formed next to the second cylindrical portion 123b to further increase the number of turns of the primary coil 14, as shown in FIG. 21. In this case, the sum of the length L2 of the second cylindrical portion 123b and the length L3 of the third cylindrical portion should be less than 30% of the total length of the spool portion 13b.

Furthermore, the portions of the ignition coil 100 other than the mold unit 10 may be formed of material, such as PBT or inexpensive material.

What is claimed is:

1. An ignition coil comprising:
a generally cylindrical center core having a plurality of cylindrical portions whose outside diameter is different from each other;
a primary coil disposed around the center core; and
a secondary coil disposed around the primary coil to boost voltage applied to the primary coil to high voltage.

2. An ignition coil as in claim 1, wherein the primary coil comprises an even number of winding layers.

3. An ignition coil as in claim 1, wherein the center core has a longitudinally extending groove by which an end of the primary coil is drawn from one end of the center core to the other end.

4. An ignition coil as in claim 1, further comprising an outer core that surrounds the center core to form a magnetic path that includes the center core and an air gap formed between the outer core and one end of the center core, wherein one of the cylindrical portions that has a smallest outside diameter is disposed adjacent to the air gap.

5. An ignition coil as in claim 1, wherein the center core is made of compressed powder of magnetic material.

6. An ignition coil as in claim 1, wherein the center core is a laminate of plural magnetic steel sheets.

7. An ignition coil as in claim 6, wherein the outer surface of the center core is covered with a thin film of insulating material.

8. An ignition coil as in claim 1, wherein the outside diameter of the cylindrical portions of the center core reduces stepwise in a longitudinal direction.

9. An ignition coil as in claim 5, the center core has a tapering wall between two of the cylindrical portions.

10. An ignition coil as in claim 1, one of the cylindrical portions adjacent to another cylindrical portion has a tapering surface tapering off from the side of the another cylindrical portion to opposite side.

11. An ignition coil as in claim 10, wherein the center core has a flange portion adjacent to the opposite side of the one of the cylindrical portion that has the tapering surface.

12. An ignition coil as in claim 1, wherein a step difference S and a difference ΔN in the number of turns of the primary coil between the cylindrical portions adjacent to each other is expressed as follows: S≧Φ×ΔN×C, wherein: Φ is an outside diameter of an electric wire of the primary coil; and C is a diameter reduction ratio of the electric wire that is wound around the cylindrical portions under a prescribed winding tension.

13. An ignition coil comprising:
a center core made of compressed powder of magnetic material;
a primary coil disposed around the center core; and
a secondary coil disposed around the primary coil,
wherein voltage applied to the primary coil is boosted to high voltage at the secondary coil.

14. An ignition coil as in claim 13, wherein the center core has a first cylindrical portion and a second cylindrical portion having a diameter that is smaller than the first cylindrical portion.

15. An ignition coil as in claim 14, wherein the primary coil comprises an even number of winding layers disposed at the first cylindrical portion and another even number of winding layers disposed at the second cylindrical portion.

16. An ignition coil as in claim 13, wherein the center core has a flange portion at an end thereof.

17. An ignition coil as in claim 16, further comprising a secondary-coil spool member disposed around the primary coil, wherein the secondary-coil spool member has a flange portion that is fixed in position by the flange portion of the center core.

18. An ignition coil as in claim 17, wherein:
the flange portion has a groove to which the flange portion of the center core fits.

19. An ignition coil as in claim 17, further comprising a mold unit for accommodating the center core, the primary coil the secondary coil and the secondary-coil spool member with resinous insulating material being disposed in gaps among the center core, the primary coil, the secondary coil and the secondary-coil spool member,
wherein the secondary-coil spool member provides a member for separating the primary coil from the secondary-coil spool member and an opening through which an end of the primary coil extends.
